(19) United States
(12) Patent Application Publication
(10) Pub. No.: US 2010/0024199 A1
(43) Pub. Date: Feb. 4, 2010

(54) Method For Correcting Slow Roll By Heating and Quenching

(75) Inventors: Yagnesh Kikaganeshwala, Cincinnati, OH (US); William Finley, Cincinnati, OH (US)

Correspondence Address: SIEMENS CORPORATION;INTELLECTUAL PROPERTY DEPARTMENT, 170 WOOD AVENUE SOUTH, ISELIN, NJ, 08830, US

(73) Assignee: Siemens Energy & Automation, Inc., Alpharetta, GA (US)

(21) Appl. No.: 12/511,367

(22) Filed: Jul. 29, 2009

Related U.S. Application Data
(60) Provisional application No. 61/085,041, filed on Jul. 31, 2008.

(51) Int. Cl. H02K 15/16

(52) U.S. Cl. 29/598

(57) ABSTRACT

An apparatus and method for correcting slow roll in a rotatable shaft is disclosed. A sensing area of a shaft is heated to a predetermined temperature while rotating the shaft in order to change electrical properties of the sensing area of the shaft. Coolant is applied to non-sensing areas of the shaft adjacent to the sensing area while the sensing area is being heated. The sensing area of the shaft is maintained at the predetermined temperature for a predetermined amount of time, and the sensing area of the shaft is quenched with coolant immediately after the predetermined amount of time in order to cool the sensing area of the shaft to room temperature.

This application claims the benefit of U.S. Provisional Application No. 61/085,041, filed Jul. 31, 2008, the disclosure of which is herein incorporated by reference.

### BACKGROUND OF THE INVENTION

The present invention relates to correcting slow roll in rotating equipment, and more particularly to an apparatus and method for correcting slow roll by heating and quenching.

Rotating equipment is used in many manufacturing applications. Excessive vibration in rotating equipment is a major concern and can result in loss of production causing manufacturing companies to lose revenue. In order to ensure that a rotating motor shaft will not have excessive vibrations when rotated by a motor, the slow roll of the shaft must be below a certain limit. The slow roll of a shaft is the vibration of the shaft when the shaft is rotated at a speed that is significantly below the typical operating speed for the shaft. For example, the slow roll of a shaft is typically determined by measuring the vibration of the shaft at approximately 250-300 revolutions per minute (rpm). The slow roll is typically checked in a balancer during a final balancing operation.

Slow roll is typically measured using eddy current probes, commonly referred to as “proximity probes”. Proximity probes work on the principle of sensing change in a magnetic field. During a slow roll measurement, the magnetic field at a certain area of a shaft can change due to a mechanical imperfection caused by a machining error or due to non-uniform electrical properties of the shaft material. This can lead to a high slow roll reading. If a high slow roll cannot be corrected, the shaft may need to be scrapped. Mechanical imperfections, such as an egg shaped bearing journal, can be detected using a dial indicator and can be corrected by re-machining the shaft. However, if the mechanical run out measured by the dial indicator is sufficiently small (e.g., less than 0.1 mil) and the slow roll reading is still high, the slow roll problem is electrical in nature. Accordingly, a method of correcting slow roll due to electrical properties of a shaft is desirable.

### BRIEF SUMMARY OF THE INVENTION

The present invention relates to correcting slow roll problems due to electrical properties of a shaft. Slow roll due to electrical properties in a shaft is commonly corrected by heating a proximity probe sensing area of a shaft and then removing the heat to let the shaft cool in air. However, the present inventors have determined that this method often does not correct the slow roll problem, and the shaft must be scrapped. Embodiments of the present invention provide a method and apparatus for correcting slow roll in which a sensing area of a shaft is heated and then immediately quenched with coolant to quickly lower the temperature of the shaft.

In one embodiment of the present invention, a sensing area of a shaft is heated to a predetermined temperature while rotating the shaft to change electrical properties of the sensing area of the shaft. Coolant can be applied to non-sensing areas of the shaft adjacent to the sensing area while the sensing area is being heated. The sensing area of the shaft is maintained at the predetermined temperature for a predetermined amount of time. Immediately after the predetermined amount of time, the sensing area of the shaft is quenched with coolant in order to cool the sensing area of the shaft to room temperature.

These and other advantages of the invention will be apparent to those of ordinary skill in the art by reference to the following detailed description and the accompanying drawings.

### BRIEF DESCRIPTION OF THE DRAWINGS

FIG. 1 illustrates an apparatus for measuring slow roll of a rotor;

FIG. 2 illustrates an apparatus for checking the mechanical runout of a shaft;

FIG. 3 illustrates an apparatus for correcting slow roll due electrical properties of a shaft according to an embodiment of the present invention; and

FIG. 4 is a flowchart illustrating a method of correcting slow roll according to an embodiment of the present invention.

### DETAILED DESCRIPTION

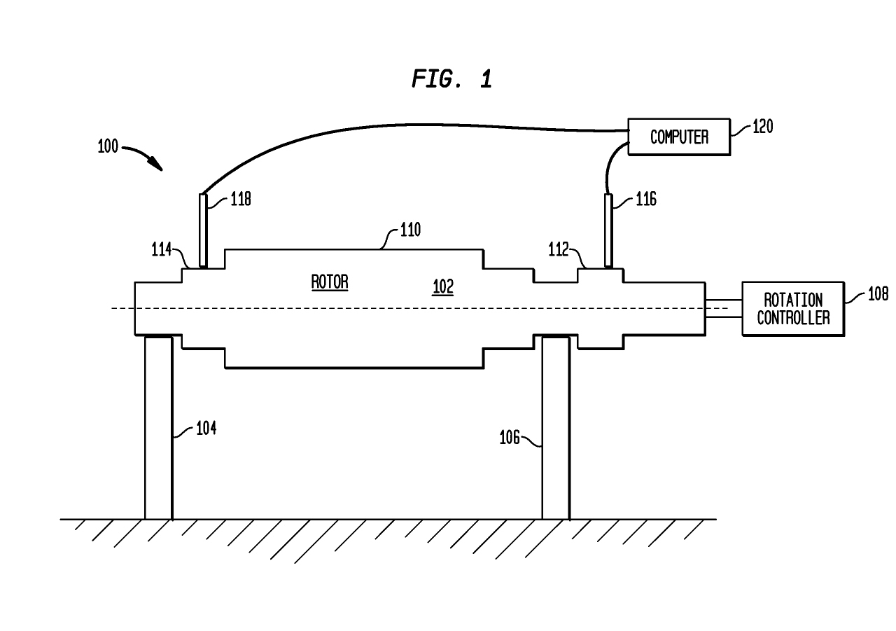

The present invention relates to correcting slow roll in rotating equipment. FIG. 1 illustrates an apparatus 100 for measuring slow roll of a rotor. As illustrated in FIG. 1, a rotor 102 is rotatably supported on pedestals 104 and 106. A rotation controller 108 controls the rotation of the rotor 102. The rotation controller 108 may comprise a motor to physically rotate the rotor 102 and a controller to control a speed of rotation of the rotor 102. The rotor 102 comprises a shaft 110 and possibly an electrical core (not shown). It is to be understood that the rotor 102 can be a rotor for any type of device and may not have an electric core. For example, pump rotor may have a shaft and an impeller. The present invention is not limited to any particular type of rotor. The rotation controller 108 can rotate the shaft 110 (via rotor 102) at a predetermined speed or within a predetermined range to measure slow roll. For example, the rotation controller 108 may rotate the shaft at approximately 250-300 revolutions per minute (rpm) to measure the slow roll.

The shaft includes sensing areas 112 and 114, and proximity probes 116 and 118 are positioned adjacent to the sensing areas 112 and 114, respectively. The proximity probes 116 and 118 measure the slow roll of the shaft 110 at the respective sensing areas 112 and 114 of the shaft 110. The location of the proximity probes 116 and 118 may be fixed in apparatus 100, and the position of the sensing areas 112 and 114 on the shaft 110 correspond to the location of the proximity probes 116 and 118, respectively. The proximity probes 116 and 118 can be implemented using eddy current probes that monitor the change in magnetic field in the respective sensing areas 112 and 114 of the shaft 110. The proximity probes 116 and 118 measure the slow roll by measuring the change in magnetic field at the sensing areas 112 and 114 as the shaft 110 is rotated. The proximity probes 116 and 118 output the slow roll readout. For example, the proximity probes 116 and 118 can transmit a signal including the slow roll readout to a computer 120, where a user can monitor the slow roll readout.

During a slow roll check, the magnetic field of the shaft can change, causing a high slow roll value, due to mechanical imperfection caused by machining error (e.g., having an egg shaped bearing journal), or due to non-uniform electrical properties of the shaft material. Mechanical imperfections in the shaft can be indentified by checking the mechanical runout.

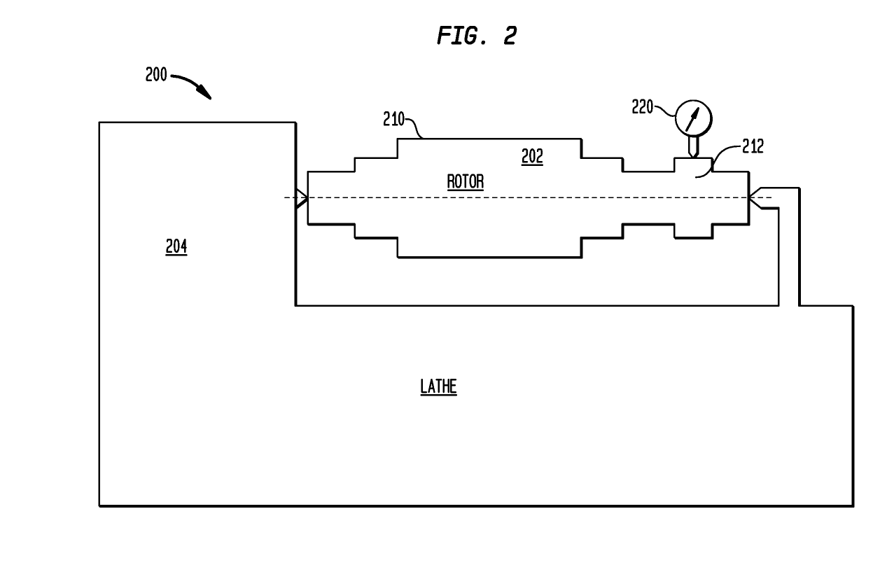

FIG. 2 illustrates an apparatus 200 for checking the mechanical runout of a shaft. As illustrated in FIG. 2, a rotor 202 is supported by a lathe 204. Although FIG. 2 illustrates a lathe 204 adapted to rotatably support the rotor 202, the present invention is not limited thereto. For example, other machines may also be adapted to support the rotor 202, such as a boring machine, broadening machine, facing machine, grinder, mill, press drill, shaper, tapping machine, and threading machine. The rotor 202 of FIG. 2 is analogous to the rotor 102 of FIG. 1, and similarly comprises a shaft 210. The shaft 210 comprises sensing area 212, which is an area where the shaft 210 is checked for shaft vibration and slow roll. A dial indicator 220 is positioned adjacent to the sensing area 212 of the shaft 210 in order to measure mechanical runout at the sensing area 212 of the shaft 210. In particular, the dial indicator 220 measures a variation the distance between the proximity probe and the sensing area 212 of the shaft 210, as the shaft 210 is rotated.

Mechanical imperfections in the shaft 210 can be indentified when the mechanical runout measured by the dial indicator 220 is greater than a threshold value (e.g., 0.1 mil). Such mechanical imperfections can be corrected by re-machining the shaft. If the mechanical runout is less than the threshold value, and the slow roll is still high, then the slow roll problem is electrical in nature.

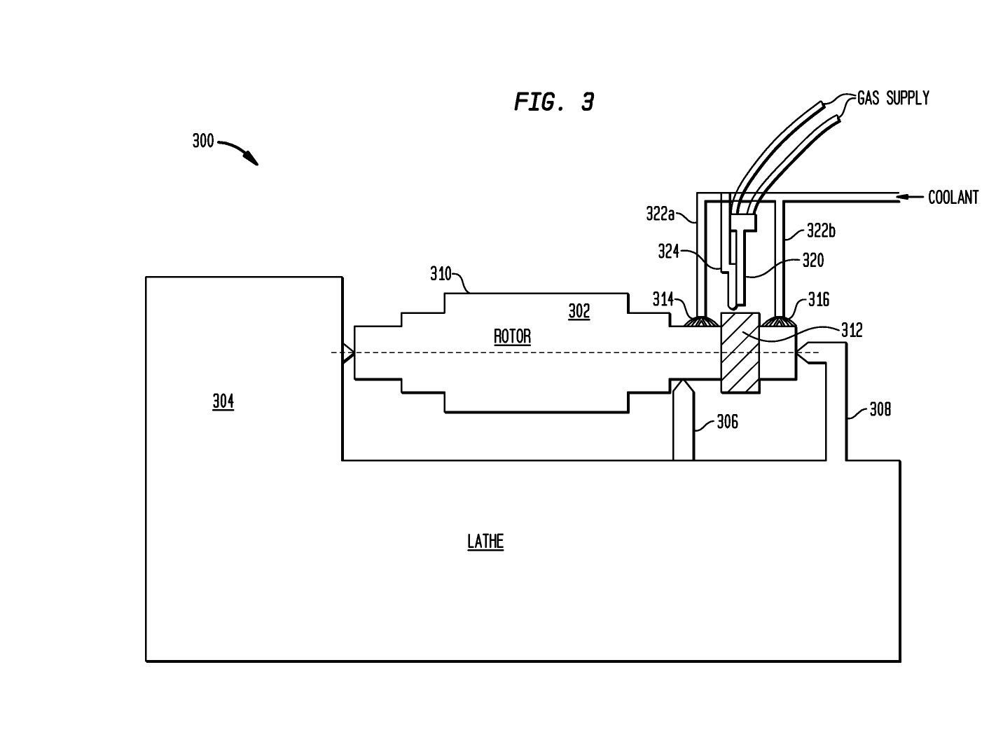

FIG. 3 illustrates an apparatus 300 for correcting slow roll due to electrical properties of a shaft according to an embodiment of the present invention. As illustrated in FIG. 3, a rotor 302 is rotatably supported by a lathe 304. Although FIG. 3 illustrates a lathe 304 adapted to rotatably support the rotor 302, the present invention is not limited thereto. For example, other machines may also be adapted to support the rotor 302, such as a boring machine, broadening machine, facing machine, grinder, mill, press drill, shaper, tapping machine, and threading machine. The rotor 302 comprises a shaft 310 having a sensing area 312 that corresponds to a position of a proximity probe (not shown). A heating element 320 heats the sensing area 312 of the shaft 320. As shown in FIG. 3, the heating element 320 can be implementing using a gas torch connected to a gas supply, but the present invention is not limited thereto. The lathe 304 can be adapted to provide supports 306 and 308 on either side of the sensing area 312 of the shaft 310. A first cooling element 322a and 322b can provide coolant to non-sensing areas 314 and 316 adjacent the sensing area 312 of the shaft 310. In particular, the first cooling element 322a and 322b can provide coolant to non-sensing areas 314 and 316 while the heating element 320 is heating the sensing area 312, such that only the sensing area 320 is heated by the heating element. A second cooling element 324 can provide coolant to the sensing area 312 of the shaft 310. According to an embodiment of the present invention, the second cooling element 324 can quench the sensing area 312 of the shaft with coolant immediately after the heating element 320 applies heat to the sensing area 312 in order to quickly bring the sensing area 312 of the shaft 310 down to room temperature. The shaft 310 is rotated while the heating element 320 heats the sensing area 312 of shaft 310, and the shaft 310 must continue to be rotated while the second cooling element 324 quenches the sensing area 312 with coolant to cool the sensing area 312 in order to prevent the shaft 310 from bending. The coolant provided via the first cooling element 322a and 322b and the second cooling element 324 can be a liquid coolant, such as water, a glycol based fluid, an oil based fluid, a silicon based fluid, a synthetic aromatic fluid, etc.

Although as illustrated in FIG. 3, the first cooling element 322a and 322b and the second cooling element 324 are implemented as separate cooling elements for providing coolant to a surface of the shaft 310, the present invention is not limited thereto. According to alternative embodiment, a single cooling element may be adapted to provide coolant to the non-sensing areas of the shaft when the sensing area is being heated and adapted to quench the sensing area with coolant immediately after heating element finishes applying heat to the sensing area. For example, the cooling element or a portion of the cooling element may be moveable to re-direct the coolant from the non-sensing areas to the sensing area.

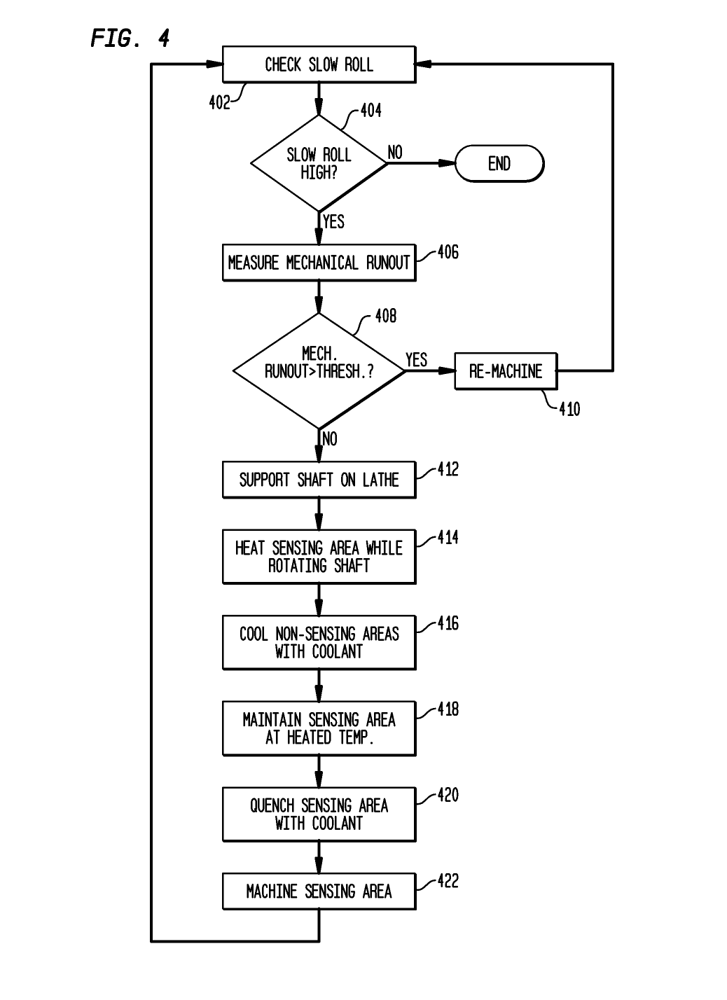

FIG. 4 illustrates a method of correcting slow roll according to an embodiment of the present invention. As illustrated in FIG. 4, at step 402 the slow roll of a shaft is checked. As described above, the slow roll of the shaft can be checked by measuring the slow roll using a proximity probe at at least one sensing area of the shaft. At step 404, it is determined if the slow roll is high. For example, if the slow roll is greater than a threshold value, the slow roll is determined to be high. If the slow roll is high the method proceeds to step 406. If the slow roll is not high, the method ends.

At step 406, the mechanical runout of the shaft is measured. As described above, the mechanical runout of the shaft can be measured using a dial indicator. At step 408, it is determined if the mechanical runout is greater than a threshold. For example, the threshold may be 0.1 mil. If, at step 408, the mechanical runout is greater than the threshold, there is a mechanical imperfection in the shaft, and the method proceeds to step 410. At step 410, the shaft is re-machined to correct the mechanical imperfection. For example, the shaft can be re-machined using a grinder or other well-known machine. After the shaft is re-machined, the method returns to step 402 to check the slow roll again. If the slow roll high, and at step 408, the mechanical runout is not greater than the threshold, the slow roll problem is due to electrical properties of the shaft, and the method proceeds to step 412.

At step 412, the shaft is supported between centers on a lathe. For example, as illustrated in FIG. 3, shaft 310 is rotatably supported by lathe 304. At step 414, the sensing area of the shaft is heated to a predetermined temperature or temperature range while rotating the shaft. The shaft may be heated to a predetermined temperature that is high enough to change the electrical properties of the shaft, but below a critical temperature so that the mechanical properties of the shaft, such as hardness, microstructure, etc., do not change. For example, according to an advantageous implementation, the shaft may be heated to approximately 800-850 degrees Fahrenheit. The shaft may be rotated at approximately 20-30 rpm while heating the shaft. As illustrated in FIG. 3, the heating element 320 is used to heat the sensing area 312 of the shaft 310 while the shaft 310 is rotated on the lathe 304. Returning to FIG. 4, at step 416, the non-sensing areas of the shaft adjacent to the sensing area are continuously cooled with a coolant. For example, as illustrated in FIG. 3, the first cooling element 322a and 322b provide coolant to the non-sensing areas 314 and 316 of the shaft 310 while the heating element 320 is heating the sensing area 312 of the shaft 310. Returning to FIG. 4, at step 418, the sensing area of the shaft is maintained at the predetermined heated temperature for a predetermined amount of time. For example, according to an advantageous embodiment of the present invention, the sensing area of the shaft may be maintained at the temperature (e.g., 800-850 degrees Fahrenheit) for 10-12 minutes.

At step 420, after the sensing area of the shaft is held at the heated temperature for the predetermined amount of time, the sensing area of the shaft is immediately quenched with coolant. The sensing area of the shaft can be immediately flushed with coolant in order to quickly bring the sensing area of the shaft down the room temperature. This cools the sensing area of the shaft significantly more quickly than if the sensing area cools in air. The shaft continues to rotate while the sensing area of the shaft is being quenched with the coolant in order to prevent the shaft from bending as the sensing area cools. As illustrated in FIG. 3, the second cooling element 324 quenches the sensing area 312 of the shaft 310 with coolant immediately after the heating element 320 stops applying heat to the sensing area of the shaft 310.

Returning to FIG. 4, at step 422, the sensing area of the shaft is machined to remove burn marks and any mechanical runout. For example, as illustrated in FIG. 3, the sensing area 312 of the shaft 310 can be machined by a grinder to remove burn marks and any mechanical runout. After the sensing area is machined, the method of FIG. 4 returns to step 402 to check the slow roll again. If the slow roll is still high, the method can be repeated. According to an embodiment of the present invention, when the method is repeated, the shaft can be heated to a higher temperature than the previous heating.

The foregoing Detailed Description is to be understood as being in every respect illustrative and exemplary, but not restrictive, and the scope of the invention disclosed herein is not to be determined from the Detailed Description, but rather from the claims as interpreted according to the full breadth permitted by the patent laws. It is to be understood that the embodiments shown and described herein are only illustrative of the principles of the present invention and that various modifications may be implemented by those skilled in the art without departing from the scope and spirit of the invention. Those skilled in the art could implement various other feature combinations without departing from the scope and spirit of the invention.

1. A method for correcting slow roll in a rotatable shaft, comprising:
heating a sensing area of the shaft to a predetermined temperature while rotating the shaft to change electrical properties of the sensing area of the shaft;
maintaining the sensing area of the shaft at the predetermined temperature for a predetermined amount of time; and
quenching the sensing area of the shaft with coolant immediately after said step of maintaining the sensing area of the shaft at the predetermined temperature for a predetermined amount of time.

2. The method of claim 1, wherein a position of the sensing area of the shaft corresponds to a location of a proximity probe adapted to measure slow roll at the sensing area of the shaft.

3. The method of claim 1, further comprising:
cooling non-sensing areas of the shaft adjacent to the sensing area of the shaft by providing coolant to the non-sensing areas of the shaft while the sensing area of the shaft is heated.

4. The method of claim 1, further comprising:
machining the sensing area of the shaft after the sensing area of the shaft is quenched with coolant.

5. The method of claim 1, wherein said step of quenching the sensing area of the shaft with coolant immediately after the sensing area of the shaft is maintained at the predetermined temperature for the predetermined amount of time comprises:
quenching the sensing area of the shaft with coolant to bring the sensing area of the shaft to room temperature.

6. The method of claim 1, wherein said step of heating a sensing area of the shaft to a predetermined temperature while rotating the shaft to change electrical properties of the sensing area of the shaft comprises:
heating the sensing area of a shaft to a predetermined temperature less than a critical temperature at which physical properties of the shaft change.

7. The method of claim 1, further comprising:
rotating the shaft while quenching the sensing area of the shaft with coolant.

8. The method of claim 1, wherein said predetermined temperature is in the range of 800-850 degrees Fahrenheit.

9. The method of claim 1, wherein said predetermined amount of time is in the range of 10-12 minutes.

10. The method of claim 1, further comprising:
rotatably supporting the shaft on a lathe prior to said heating step.

11. An apparatus for correcting slow roll in a rotatable shaft, comprising:
means for heating a sensing area of the shaft to a predetermined temperature to change electrical properties of the sensing area of the shaft;
means for rotating the shaft while the sensing area of the shaft is being heated;
means for maintaining the sensing area of the shaft at the predetermined temperature for a predetermined amount of time; and
means for quenching the sensing area of the shaft with coolant immediately after said predetermined amount of time.

12. The apparatus of claim 11, wherein a position of the sensing area of the shaft corresponds to a location of a proximity probe adapted to measure slow roll at the sensing area of the shaft.

13. The apparatus of claim 11, further comprising:
means for cooling non-sensing areas of the shaft adjacent to the sensing area of the shaft by providing coolant to the non-sensing areas of the shaft while the sensing area of the shaft is heated.

14. The apparatus of claim 11, further comprising:
means for machining the sensing area of the shaft after the sensing area of the shaft is quenched with coolant.

15. The apparatus of claim 11, wherein said means for heating a sensing area of the shaft to a predetermined temperature while rotating the shaft to change electrical properties of the sensing area of the shaft comprises:
means for heating the sensing area of a shaft to a predetermined temperature less than a critical temperature at which physical properties of the shaft change.

16. The apparatus of claim 11, further comprising:
means for rotating the shaft while the sensing area of the shaft is quenched with coolant.

17. The apparatus of claim 11, further comprising:
means for rotatably supporting the shaft.

18. An apparatus for correcting slow roll in a rotatable shaft comprising:
a heating element adapted to apply heat to a sensing area of a shaft to heat the sensing area of the shaft to a predetermine temperature and to maintain the sensing area of the shaft at the predetermined temperature for a predetermined amount of time; and
a cooling element adapted to quench the sensing area of the shaft with coolant immediately after the sensing area of the shaft is maintained at the predetermined temperature for the predetermined amount of time.

19. The apparatus of claim 18, further comprising:
a second cooling element adapted to provide coolant to non-sensing areas of the shaft while the sensing area of the shaft is heated by the heating element.

20. The apparatus of claim 18, wherein the cooling element is further adapted to provide coolant to non-sensing areas of the shaft while the sensing area of the shaft is heated by the heating element.

21. The apparatus of claim 18, further comprising:
a lathe adapted to rotatably support the shaft.

22. The apparatus of claim 21, wherein said lathe is adapted to rotate the shaft when the sensing area of the shaft is being heated by the heating element and when the sensing area of the shaft is being quenched with coolant by the cooling element.

23. The apparatus of claim 18, wherein a position of the sensing area of the shaft corresponds to a location of a proximity probe adapted to measure slow roll at the sensing area of the shaft.

24. The apparatus of claim 18, wherein said heating element comprises a gas torch.
